(19) United States
(12) Patent Application Publication
(10) Pub. No.: US 2024/0399574 A1
(43) Pub. Date: Dec. 5, 2024

(54) CONTROL SYSTEM AND METHOD FOR CONTROLLING OPERATION OF A MACHINE IN AN INDUSTRIAL ENVIRONMENT

(71) Applicant: LM Wind Power A/S, Kolding (DK)

(72) Inventors: Fritz Andres Campo, New Orleans, LA (US); Chad Marshall, New Orleans, LA (US)

(21) Appl. No.: 18/695,630

(22) PCT Filed: Sep. 27, 2021
(86) PCT No.: PCT/US2021/052179

§ 371 Date: Mar. 26, 2024

(51) Int. Cl. B25J 9/16

(52) U.S. Cl. CPC B25J 9/1664; B25J 9/1694

(57) ABSTRACT

Embodiments of present disclosure relates to efficient control system and method for controlling operation of at least one machine in an industrial environment. The control system comprises a target path correction unit and a position correction unit. The target path correction unit is configured to modify a target path fed to the at least one machine, based on real-time spatial position of the at least one machine. The position correction unit is configured to correct real-time operating position of the at least one machine. The position correction unit corrects the real-time operating position by sensing one or more parameters related to the at least one machine and displacing operating tool of the at least one machine, based on the one or more parameters. The control system achieves tight tolerance in manufacturing of large structures inexpensively and eliminates the need of high skilled operator to operate the machine.

### TECHNICAL FIELD

The present subject matter is related in general to control systems, more particularly, but not exclusively to a method and system for controlling operations of a machine in an industrial environment.

### BACKGROUND

In conventional systems and methods, manufacturing of large structures requires controlling tolerance in order of millimeters. The large structures may be wind turbine blades, shell roof, and so on. on. The tolerance may be permissible limit or limits of variation in a physical dimension, for a measured value of physical property associated with the large structures. The tolerance is required for the large structures that could be 100 m long or more. Controlling of the tolerance is important to make sure that error occurring during manufacturing of each part of a large structure is within allowable or permissible limits. Thus, such controlling may help in manufacturing higher quality products or structures and provisions fewer mistakes when manufacturing. Assembly of the large structures is made possible with use of adhesive that allows for most efficient use of the large structures and maximize their potential. The need of such tolerances and strength of adhesives results in desired geometric requirements which affect performance of the large structures. However, in some cases, the performance may be largely reduced with the adhesive thickness. Also, paying for expensive adhesive may be considered not desirable, to overcome the unattainable tolerances. Beyond that, higher performance adhesives, and a lower cost per square meter, such as film adhesives, may not be feasible in a manufacturing scenario due to incapability of controlling bond tolerances. Also, such adhesives may not be feasible during assembly of such large structures with large components.

For example, consider an operation of cutting work on workpieces such as wind turbine blades. The cutting work on the wind turbine blades is usually roughed out by a manual or ordinary processing cutting machine. Upon which, finishing process is done by a finishing machine. The finishing process aims at altering surface of the manufactured structure in order to achieve some particular characteristics. The commonly desired characteristic includes improved aesthetic, adhesion, solderability, hardness and so on. Such manual processing on the machinery generally may have low precision. Especially for processing the workpieces of large volume with high precision, requires finishing machines such as Computer Numerical Control (CNC) machine tools and machining centers. Such finishing machines may be indispensable. Also, such finishing machines are often expensive, bulky, and complicated to operate. For individuals or factories that produce individual high-precision workpieces for small batches, it is obviously impractical to purchase and use the finishing machine that is expensive, bulky, and complicated to operate.

Currently, a combination of expensive tools, and a large amount of rework may be seen in many operations on large structures, such as a grinding operation. Such operations may require a very highly skilled operator to achieve desired tolerance demands. The impact of these problems is seen in Non-Conformance Reports (NCR's) that includes construction-related documents, addressing specifications of work that fails to meet quality standards, overdesign, cycle time penalties, and over all Bill Of Materials (BOM) cost. Moreover, NCRs are required to perform the operations such as manufacturing, grinding, cutting, repairing and so on.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a control system for controlling operation of at least one machine in an industrial environment. The control system comprises a target path correction unit and a position correction unit. The target path correction unit is configured to modify a target path fed to the at least one machine, based on real-time spatial position of the at least one machine. The position correction unit is configured to correct real-time operating position of the at least one machine. Further, the position correction unit corrects the real-time operating position by sensing one or more parameters related to the at least one machine. Upon sensing the one or more parameters, the control system displaces operating tool of the at least one machine to correct the real-time operating position.

In an embodiment, the present disclosure relates to a method for controlling operation of at least one machine in an industrial environment. The method comprises modifying a target path fed to at least one machine in an industrial environment, based on real-time spatial position of the at least one machine. Further, the method comprises correcting real-time operating position of the at least one machine. The real-time operating position is corrected by sensing one or more parameters related to the at least one machine and displacing operating tool of the at least one machine, based on the one or more parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives, and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 shows an exemplary environment of a control system for controlling an operation of at least one machine in an industrial environment, in accordance with some embodiments of the present disclosure:

FIG. 2 shows a detailed block diagram of a control system for controlling an operation of at least one machine in an industrial environment, in accordance with some embodiments of the present disclosure;

FIG. 3 illustrates exemplary embodiment for controlling an operation of at least one machine in an industrial environment, in accordance with some embodiments of present disclosure;

FIG. 4 illustrates an exemplary embodiment for correcting target path of at least one machine in an industrial environment, in accordance with some embodiments of present disclosure;

FIGS. 5a and 5b illustrate exemplary embodiments for correction of real-time operating position of an operating tool of at least one machine in an industrial environment, in accordance with some embodiments of present disclosure;

FIG. 6a illustrates a flowchart showing an exemplary method for controlling operation of at least one machine in an industrial environment, in accordance with some embodiments of present disclosure;

FIG. 6b illustrates a flowchart showing an exemplary method for correcting operating position of an operating tool of at least one machine in an industrial environment, in accordance with some embodiments of present disclosure; and

FIG. 7 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “includes”, “including”, or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Present disclosure relates to a control system and method for controlling operation of at least one machine in an industrial environment. The proposed system is coupled with a target path correction unit and a position correction unit. The proposed system receives a target path that is to be corrected for the at least one machine. The target path is the path that is followed by the operator to perform plurality of operations on very large structures The target path is obtained based on the real-time spatial position of the at least one machine. Further, upon detecting deviation in the path followed by the operator and the target path, the proposed system displaces the operating tool for correcting real-time operating position of the at least one machine. Displacing the operating tool is based on the one or more parameters sensed by one or more sensors. By correcting the target path and the real-time spatial position, the proposed system eliminates the use of high skilled operator to operate the tool and provides low-cost correction mechanism.

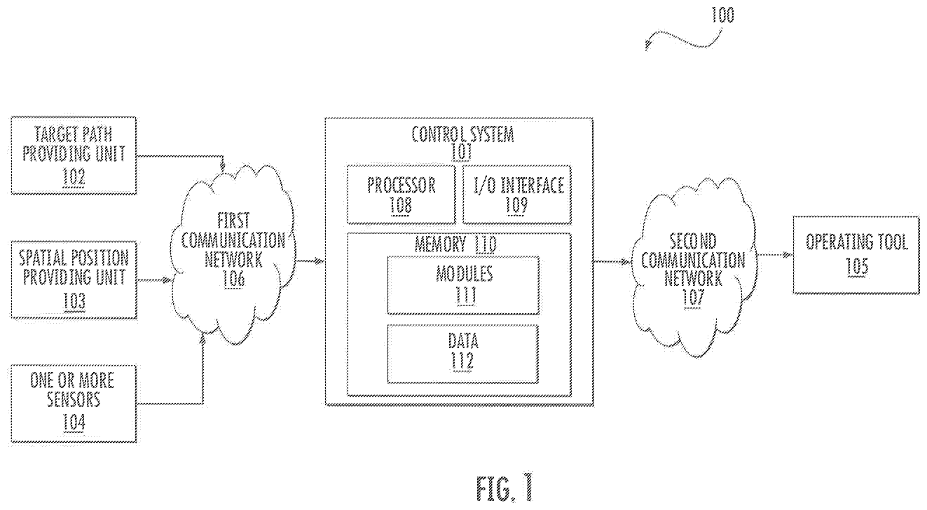

FIG. 1 shows an exemplary environment 100 of a control system 101 for controlling the operation of at least one machine in an industrial environment. The exemplary environment 100 may include the control system 101, a target path providing unit 102, a spatial position providing unit 103, one or more sensors 104, an operating tool 105, a first communication network 106, and a second communication network 107. In an embodiment, the exemplary environment 100 may be environment of an industry. The industry may be a manufacturing industry such as metal manufacturing industry, automobile manufacturing industry, furniture manufacturing industry and so on. The industry may be a heavy industry such as aerospace industry, shipbuilding industry and a wind power industry, and so on. In an embodiment, the exemplary environment 100 may be an interior of the industry where plurality of operations like cutting, grinding, trimming, surface preparation, repair, finishing process and so on, may be performed on large structures. The large structures may be wind blades, shell roof and so on.

The control system 101 may be implemented for controller the plurality of operations performed by at least machine on the large structures. The control system 101 may be configured to perform the steps of the present disclosure to control the plurality of operations. The control system 101 may be configured to receives target path from the target path providing unit 102. The real-time spatial position may be provided by the spatial position providing unit 103 to modify the target path of the at least one machine. The one or more sensors 104 may be configured with the control system 101 to sense one or more parameters of the at least one machine. In an embodiment, the target path providing unit 102 and the spatial position providing unit 103 may communicate with the control system 101 via the first communication network 106. The control system 101 may be configured to control the operating tool 105, for correcting the real-time operating position of the at least one machine. The real-time operating position is corrected based on the one or more parameters that are sensed by the one or more sensors 104 in communication with the control system 101. In an embodiment, the control system 101 may communicate to the operating tool 105 via the second communication network 107. In an embodiment, the control system 101 may communicate with each of the target path providing unit 102, the spatial position providing unit 103, the one or more sensors 104 and the operating tool 105 via a dedicated communication network. In an embodiment, each of the first communication network 106 and the second communication network 107 may include, without limitation, a wired connection, Local Area Network (LAN), Wide Area Network (WAN), Controller Area Network (CAN), or a wireless connection (e.g., using Wireless Application Protocol), the Internet, and the like. In an embodiment, a dedicated communication network may be implemented to establish communication between the control system 101 and each of the target path providing unit 102, the spatial position providing unit 103, one or more sensors 104, and the operating tool 105.

The at least one machine may be configured to perform an operation on a large structure. The operation may be performed based on target path that is fed to the at least one machine. In an embodiment, the at least one machine may be a grinding machine, welding machine, cutting machine and so on. In an embodiment, the at least one machine may be handheld by an operator who is present at location of the industry near the large structure. In an embodiment, the at least one machine may include an operating tool. The operating tool may be placed on surface of the large structure to the perform the operation. For example, for the cutting machine, the operating tool may be a blade which helps in cutting the large structure.

The target path that is fed to the at least one machine may be a virtual path that is to be followed by the operator. In an embodiment, the at least one machine may be configured to automatically function to follow the target path, for performing the operation. In an embodiment, the target path may be obtained using augmented reality or virtual reality techniques. A primary operation may be providing one or more inputs using such techniques to generate the target path for the at least one machine. The one or more inputs may be movement of the primary operator who is wearing HoloLens, gestures of the primary operator and so on.

The control system 101 may include a processor 108, I/O interface 109, and a memory 110. In some embodiments, the memory 110 may be communicatively coupled to the processor 108. The memory 110 stores instructions, executable by the processor 108, which, on execution, may cause the control system 101 to control the operation of the at least one machine, as disclosed in the present disclosure. In an embodiment, the memory 110 may include one or more modules 111 and data 112. The one or more modules 111 may be configured to perform the steps of the present disclosure using the data 112, to control the operations of the at least one machine in the industrial environment. In an embodiment, each of the one or more modules 111 may be a hardware unit which may be outside the memory 110 and coupled with the control system 101. The control system 101 may be implemented in controlling a variety of operations such as manufacturing, cutting, finishing, grinding, welding, and assembling and so on.

The control system 101 may be configured to control the operation of the at least one machine by correcting the target path fed to the at least one machine. For correcting the target path, a real-time spatial position of the at least one machine may be obtained. The target path may be corrected using the real-time spatial position. The real-time spatial position may indicate position of the at least one machine in a surrounding area of the industrial environment. In an embodiment, the real-time spatial position may be the position of the at least one machine on the surface of the large structure. The control system 101 may be configured to receive the real-time spatial position from the spatial position providing unit 103. In an embodiment, the spatial position providing unit 103 may implement a scanning mechanism such as a laser scanner for determining the real-time spatial position. In an embodiment, the scanning mechanism may be deployed, but is not limited to, near wind turbine, walls of industry, proximal to the large structure and so on. One or more techniques, known to person skilled in the art, may be implemented to determine the real-time spatial position of the at least one machine. In an embodiment, the control system 101 may be coupled with the target path providing unit 102 to receive the target path that is to be modified based on the real-time spatial position of the at least one machine. In an embodiment, for modifying the target path, tolerance of the operation of the at least one machine may be calculated by checking if the real-time spatial position is in line with the target path. Upon the calculation, if the tolerance is detected to be greater than a predefined threshold value, the control system 101 may be configured to modify the target path. In an embodiment, the control system 101 may be configured to modify the target path to minimize the tolerance.

Further, for controlling the operation of the at least one machine, the control system 101 may be configured to correct real-time operating position of the at least one machine. The real-time operating position of the at least one machine indicates at least one of direction and force of operation of the operating tool 105. For correcting the real-time operating position, the control system 101 may be configured with the one or more sensors 104 for sensing the one or more parameters related to the at least one machine. In an embodiment, the one or more sensors 104 may include, but are not limited to, piezoelectric sensor, accelerometer sensor, gyroscope and so on. The one or more parameters may include, but are not limited to, linear acceleration, angular acceleration, orientation, velocity, and trajectory of the at least one machine. Upon sensing, the control system 101 may be configured to displace the operating tool 105 to correct the operating position of the at least one machine. The control system 101 may be configured to displace the operating tool 105 based on the one or more parameters. In an embodiment, the position correction unit 202 for displacing the operating tool 105 may comprises a holding structure configured to hold the operating tool 105 and the one or more actuators configured to displace the operating tool 105. In an embodiment, the operating tool 105 may be displaced to minimize value of deviation between the one or more parameters 208 and one or more predefined parameters to zero.

In an embodiment, to correct the real-time operating position of the at least one machine, the control system 101 may be configured to use two sets of sensors. The two sets of sensors may be used to obtain error between the target path and the path followed by operator. The two sets of sensors include a laser tracker and a set of encoders. The laser tracker is used to find position of frame of correction mechanism in space at low frequency/rate. While the set of encoders are used to capture deviation with respect to speed and accuracy of operation of the at least one machine, during the operation.

In an embodiment, the control system 101 may receive data for controlling the operation via the I/O interface 109. The received data may include, but is not limited to, at least one of the target path, the real-time spatial position, the real-time operating position, one or more parameters and so on. Also, the control system 101 may transmit data, for controlling the operation, via the I/O interface 109. The transmitted data may include, but is not limited to, modified target path, corrected position, alerts, and so on.

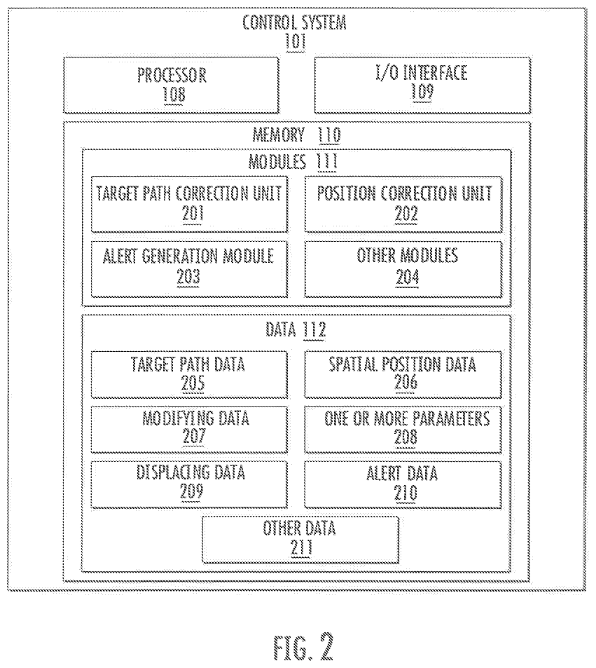

FIG. 2 shows a detailed block diagram of the control system 101 for controlling the operation of the at least one machine in the industrial environment, in accordance with some embodiments of the present disclosure.

The data 112 and the one or more modules 111 in the memory 110 of the control system 101 is described herein in detail.

In one implementation, the one or more modules 111 may include, but are not limited to, a target path correction unit 201, a position correction unit 202, an alert generation module 203, and one or more other modules 204, associated with the control system 101.

In an embodiment, the data 112 in the memory 110 may include target path data 205, spatial position data 206, modifying data 207, one or more parameters 208, displacing data 209, alert data 210, and one or more other data 211 associated with the control system 101.

In an embodiment, the data 112 in the memory 110 may be processed by the one or more modules 111 of the control system 101. In an embodiment, the one or more modules 111 may be implemented as dedicated units and when implemented in such a manner, said modules may be configured with the functionality defined in the present disclosure to result in a novel hardware.

The one or more modules 111 of the present disclosure function to control the operation of the at least one machine in the industrial environment. The one or more modules 111 along with the data 112, may be implemented in any control system 101, for controlling the operation of the at least one machine.

The target path correction unit 201 of the control system 101 may be configured to modify the target path based on the real-time spatial position of the at least one machine. The target path may be received and stored as the target path data 205 in the memory 110. The real-time spatial position may indicate position of the at least one machine within the industrial environment. In an embodiment, the real-time spatial position may include, but is not limited to, distance of the at least one machine on the surface of a large structure from center point of the large structure, distance from a corner of the industrial environment, distance from nearest edge of the large structure, and so on. In an embodiment, the real-time spatial position may be determined in real-time. The real-time spatial position may be determined continuously when performing correction of the operation. In an embodiment, the real-time spatial position may be stored as the spatial position data 206 in the memory 110. In an embodiment, the real-time spatial position may be in form of a raster data or a vector data. The raster data is a type of spatial data that consists of matrix of cells organized into rows and columns representing specific information. Similarly, the vector data is a type of spatial data used for storing data that has discrete boundaries. In another embodiment, the real-time spatial position may be stored in any other form, known to a person skilled in the art.

The target path correction unit 201, upon receiving the target path, may be configured to calculate the tolerance of the operation of the at least one machine. The target path correction unit 201 may calculate the tolerance by checking if the real-time spatial position is in line with the target path of the at least one machine. Upon calculating the tolerance, if the tolerance is detected to be greater than the predefined threshold value, a difference in the tolerance value is obtained. In an embodiment, the difference in the tolerance value may be referred to as the modifying data 207. The modifying data 207 may be used for the correction of the target path. The target path provided to the operator to follow may be corrected using the modifying data 207, to minimize the tolerance of the operation of the at least one machine.

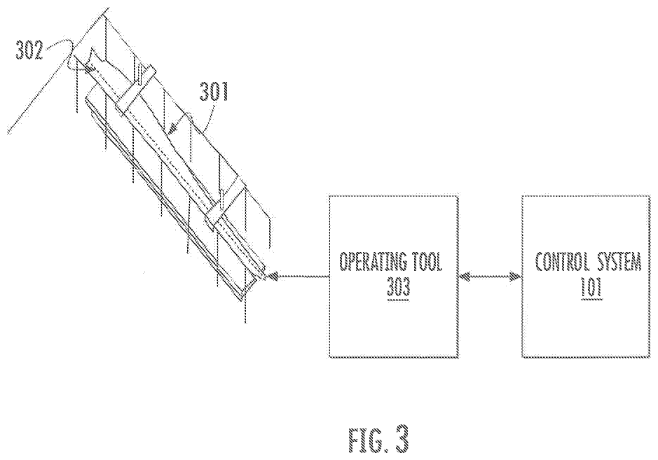

For example, FIG. 3 illustrates exemplary embodiment for controlling an operation of the at least one machine in an industrial environment, in accordance with some embodiments of present disclosure. FIG. 3 comprises a wind blade 301, a virtual path 302, an operating tool 303 and a control system 101. Consider the industrial environment illustrated in FIG. 3 is of a wind power industry for manufacturing of the wind blade 301. The wind blade 301 is manufactured with very tight tolerance and is being developed at low cost in the industrial environment. The manufacturing of the wind blade 301 may require, but is not limited to, a cutting process, a finishing process and so on. The operator is provided with the operating tool 303 to perform the operation on the wind blade 301. Consider the operation that is to be performed is the cutting process. The operation may be performed by the operator using target path 302. For the cutting the wind blade 301, the operating tool 303 needs to follow path of the target path 302 on the wind blade 301. During the operation, the real-time spatial position of the at least one machine is obtained. After obtaining the real-time spatial position, the target path 302 that is to be provided to the user may be corrected, such that tolerance of the operation is minimized.

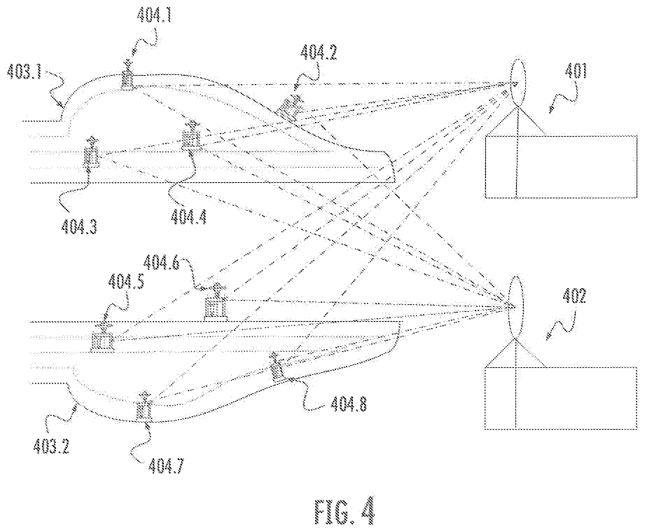

FIG. 4 illustrates an exemplary embodiment for correcting the target path of the at least one machine in the industrial environment, in accordance with some embodiments of present disclosure.

Consider a scenario where in the industrial environment, operation need to be performed on multiple wind blades using respective machines. As illustrated in FIG. 4, multiple wind blades may be first wind blade 403.1 and a second wind blade 403.2.

The at least one machine associated with the first wind blade 403.1 may include a first machine 404.1, a second machine 404.2, a third machine 404.3 and a fourth machine 404.4. The at least one machine associated with the second wind blade 403.2 may include a fifth machine 404.5, a sixth machine 404.6, a seventh machine 404.7 and an eight machine 404.8. In an embodiment, the target path correction unit 201 for correcting target path of operation performed on the first wind blade 403.1 and the second wind blade 403.2 may include a first laser tracker 401 and a second laser tracker 402. In an embodiment, the machines 404.1, 404.2, 404.3, 404.4, 404.5, 404.6, 404.7 and 404.8 may be monitored by the first laser tracker 401 and the second laser tracker 402, for determining the real-time spatial position of each of the machines 404.1, 404.2, 404.3, 404.4, 404.5, 404.6, 404.7 and 404.8. In an embedment, beacons may be placed on the machines 404.1, 404.2, 404.3, 404.4, 404.5, 404.6, 404.7 and 404.8, to enable the first laser tracker 401 and the second laser tracker 402 to monitor and trach the real-time spatial positions of the machines 404.1, 404.2, 404.3, 404.4, 404.5, 404.6, 404.7 and 404.8. For example, consider there is a deviation between the target path and the path followed by the operator using the operating tool 404.3. The first laser tracker 401 scans the first wind blade 403.1 to obtain the real-time spatial position of the at least one machine. Upon obtaining, the real-time spatial position, the target path correction unit 201 may be configured to correct the target path. The target path correction unit 201, calculates the tolerance of operation of each of the machines. The target path correction unit 201 may calculate the tolerance by checking if the real-time spatial position is in line with the target path of respective machine. Upon calculating, if the tolerance is detected to be greater than the predefined threshold value, the target path followed by the operator is modified by displacing corresponding machine. By modifying the target, the tolerance of operation of the at least one machine may be minimized.

The position correction unit 202 may be configured to correct the real-time operating position of the at least one machine. The position correction unit 202 may be configured to receive the one or more parameters 208 related to the at least one machine. The one or more parameters 208 are sensed by the one or more sensors 104. The one or more parameter 208 may include, but is not limited to, at least one of angular acceleration, linear acceleration, orientation velocity and trajectory related to the at least one machine. The one or more parameters 208 may be compared with the one or more predefined parameters to obtain the displacing data 209. The displacing data 209 may indicate difference between the one or more parameters 208 and the one or more predefined parameters, which is obtained after the comparison In an embodiment, the one or more predefined parameters may indicate optimal values of the one or more parameters 208 that may be required to perform desired operation. Upon obtaining the displacing data 209, the position correction unit 202 may be configured with one or more actuators to displace the operating tool 105 for minimizing value of deviation or error. The real-time operating positions of the at least one machine may indicate at least one of directions and force of operation of the operating tool 105. The one of direction of the operating tool 105 may include, but is not limited to, linear direction, radial direction, and so on. The force of operation of the operating tool 105 may include, but is not limited to, thrust force, torque force, traverse force, and so on. Thus, by displacing the operating tool 105, the position correction unit 202 corrects the real-time operating position of the at least one machine to minimize the deviation.

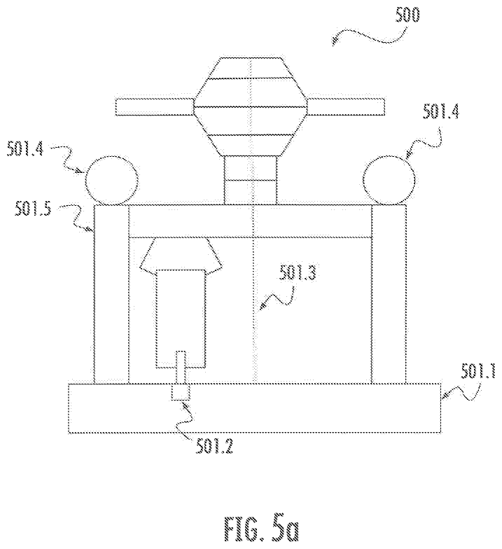

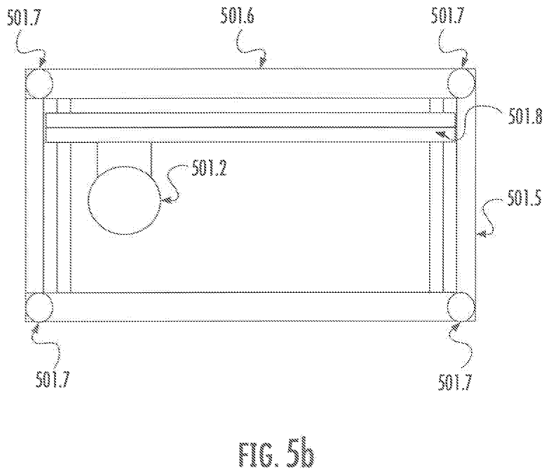

For example, FIGS. 5a and 5b illustrate exemplary embodiments for correcting of the real-time operating position of the operating tool 105 of the at least one machine in the industrial environment, in accordance with some embodiments of present disclosure. In an embodiment, an at least one machine 500 may include, a surface 501.1 of the large structure, an operating tool 501.2, laser tracker beacons 501.4. Axis 501.3 indicates vertical axis of the at least one machine 500. The laser tracker beacons 501.4 may be used to determine the real-time spatial position of the at least one machine 500, for modifying the target path. The real-time operating position of the at least one machine 500 indicates at least one of direction and force of operation of the operating tool 501.2. The one of direction of the operating tool 501.2 may include, but is not limited to, linear direction, radial direction, and so on. The force of operation of the operating tool 501.2 may include, but is not limited to, thrust force, torque force, traverse force, and so on. In an embodiment, the at least one machine 500 may further comprise a frame 501.5, a tool holder 501.6, sensors 501.7 and a servomotors 501.8. The frame 501.5 along with the tool holder 501.6 together may constitute to holding structure of the at least one machine 500. The sensors 501.7 may be used to sense the one or more parameters 208 related to the at least one machine 500. Further, the operating tool 501.2 may be displaced based on the one or more parameters 208, for correcting the real-time operating position of the at least one machine 500. For displacing the operating tool 501.2, the servomotors 501.8 may act as the one or more actuators. The servomotors 501.8 may displace the operating tool 501.2 for minimizing value of the deviation between the one or more parameters 208 and the one or more predefined parameters to zero. For displacing the operating tool 501.2, the servomotors 501.8 may function to move the operating tool parallel to the axis 501.3. The operating tool 501.2 may be displaced to coincide with the target path on the surface 501.1. In an embodiment, accelerometers and gyroscopes may be incorporated, and several algorithms exist to minimize bias and error in operating the at least one machine 500.

In an embodiment, the one or more other modules 204 may include an operation speed detection unit (not shown in figure) which may be configured to detect speed of operation of the at least one machine. In an embodiment, the operation speed detection unit may comprise one or more encoders to capture high speed and high accuracy deviations. The one or more encoders may be placed such that the one or more encoders rotate with movement of the operating tool 501.2. The one or more encoders may output pluses which are used to detect the speed of operation. In an embodiment, at least one of pulse counting or pulse timing of the pulses may be used to detect the speed of operation. In an embodiment, the speed of operation may be compared with a threshold range of speeds. The threshold range of speeds may indicate optimal values of the speed of the operating tool 105, that is required for performing the operation. When the speed of operation is not within the threshold range of the speed, the operator may be alerted. Based on the alert, the operator may change the speed to reach the threshold range of the speeds.

In an embodiment, the alert generation module 203 may be configured to provide alerts in the industrial environment. The alert may be provided to the operator operating the at least one machine or the primary operator. In an embodiment, the alters may be provides when the target path is to be modified or the real-time operating position is to be corrected, or when speed of the operation is not within the threshold range of the speed. In an embodiment, the alerts may be in form of audio, visual or text. Such alert that is to be generated by the alert generation module 203 may be stored as the alert data 210 in the memory 110.

The other data 211 may store data, including temporary data and miscellaneous data, generated by modules for performing the various functions of the control system 101. The one or more modules 111 may also include other modules 204 to perform various miscellaneous functionalities of the control system 101. It will be appreciated that such modules may be represented as a single module or a combination of different modules.

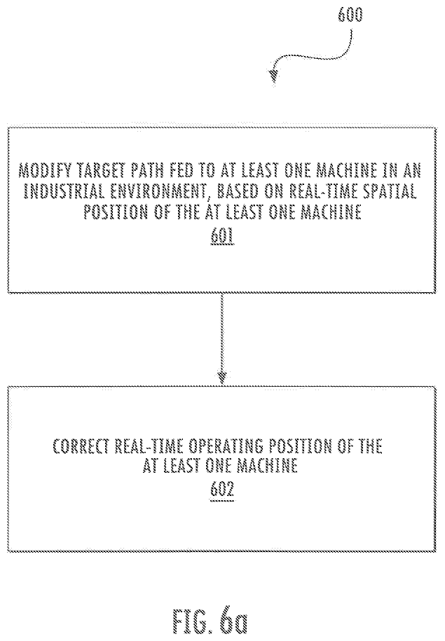

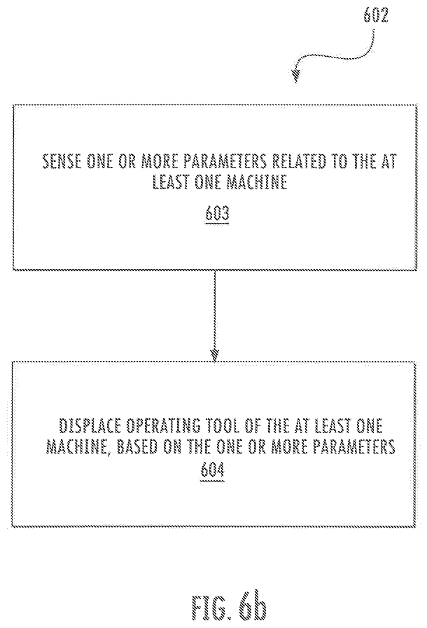

FIG. 6a illustrates a flowchart showing an exemplary method for controlling operation of the at least one machine in the industrial environment, in accordance with some embodiments of present disclosure.

At block 501, the target correction unit 201 of the control system 101 may be configured to correct the target path based on the real-time spatial position of at least one machine. The target path of the at least one machine is determined using an augmented reality of the industrial environment. One or more inputs may be provided by the primary operator based on the augmented reality to obtain the target path that is to be modified.

The target path of at least one machine is modified by calculating tolerance of operation of the at least one machine. The tolerance is calculated by checking if the real-time spatial position of the at least one machine is in line with the target path of the at least one machine. Upon calculation, if the tolerance of the operation is detected to be greater than the predefined threshold value then the target path needs to be modified. The target path of the at least one machine is modified to minimize the tolerance.

At block 502, the position correction unit 202 of the control system 101 may be configured to correct the real-time operating position of the at least one machine. FIG. 6b illustrates a flowchart showing an exemplary method for correcting the real-time operating position of the operating tool 105 of the at least one machine.

At block 603, the one or more parameters 208 of the machine are sensed by the one or more sensors 104 of the position correction unit 202. The one more parameters 208 comprises of at least one of angular acceleration, linear acceleration, orientation, velocity, and trajectory related to the at least one machine. The one or more parameters 208 are compared with the one or more predefined parameters to obtain deviation of the tolerance of the operation.

At block 604, the one or more actuators of the position correction unit 202 may be configured to displace the operating tool 105 of the at least one machine based on the one or more parameters 208. The operating tool 105 corrects the real-time operating position of the at least one machine, by minimizing value of deviation between the one or more parameters 208 that is sensed by the one or more sensors 104 and the one or more predefined parameters to zero.

In an embodiment, the proposed method is performed in real-time, when performing the operation on the large structure using the at least one machine. The control system 101 may be configured to dynamically control the operation to minimize the tolerance and increase the accuracy of the operation.

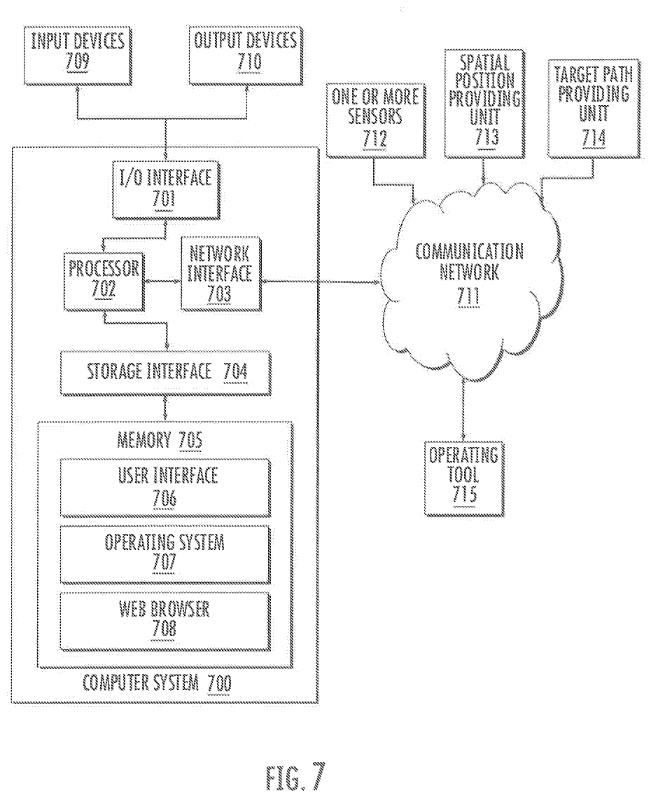

FIG. 7 illustrates a block diagram of an exemplary computer system for implementing embodiments consistent with the present disclosure. In an embodiment, the computer system 700 is used to implement the control system 101. The computer system 700 may include a central processing unit (“CPU” or “processor”). The processor 702 may include at least one data processor for executing processes in Virtual Storage Area Network. The processor 702 may include specialized processing units such as, integrated system (bus) controllers, memory management control units, floating point units, graphics processing units, digital signal processing units, etc.

The processor 702 may be disposed in communication with one or more input/output (I/O) devices 709 and 710 via I/O interface 701. The I/O interface 701 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 701, the computer system 700 may communicate with one or more I/O devices 709 and 710. For example, the input devices 709 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 710 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 700 may consist of the control system 101. The processor 702 may be disposed in communication with the communication network 711 via a network interface 703. The network interface 703 may communicate with the communication network 711. The network interface 703 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 711 may include, without limitation, a direct interconnection, local area network (LAN), wide area network (WAN), wireless network (e.g., using Wireless Application Protocol), the Internet, etc. Using the network interface 703 and the communication network 711, the computer system 700 may communicate with one or more sensors 712, spatial position providing unit 713, target path providing unit 714 and operating tool 715 for controlling the operation of the at least one machine in an industrial environment. The network interface 703 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 711 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 702 may be disposed in communication with a memory 705 (e.g., RAM, ROM) via a storage interface 704. The storage interface 704 may connect to memory 705 including, without limitation, memory drives, removable disc drives, etc., employing connection protocols such as, serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 705 may store a collection of program or database components, including, without limitation, user interface 706, an operating system 707 etc. In some embodiments, computer system 700 may store user/application data 706, such as, the data, variables, records, etc., as described in this disclosure. Such databases may be implemented as fault-tolerant, relational, scalable, secure databases such as Oracle (R) or Sybase (R).

The operating system 707 may facilitate resource management and operation of the computer system 700. Examples of operating systems include, without limitation, APPLE MACINTOSH® OS X, UNIXR, UNIX-like system distributions (E. G., BERKELEY SOFTWARE DISTRIBUTION™ (BSD), FREEBSD™, NETBSD™ OPENBSD™, etc.), LINUX DISTRIBUTIONS™ (E. G., RED HAT™, UBUNTU™, KUBUNTU™, etc.), IBM™ OS/2, MICROSOFT™ WINDOWS™ (XP™ VISTA™/7/8, 10 etc.), APPLE® IOS™ GOOGLE® ANDROID™ BLACKBERRY® OS, or the like.

In some embodiments, the computer system 700 may implement a web browser 708 stored program component. The web browser 708 may be a hypertext viewing application, such as Microsoft Internet Explorer, Google Chrome, Mozilla Firefox, Apple Safari, etc. Secure web browsing may be provided using Hypertext Transport Protocol Secure (HTTPS), Secure Sockets Layer (SSL), Transport Layer Security (TLS), etc. Web browsers 708 may utilize facilities such as AJAX, DHTML, Adobe Flash, JavaScript, Java, Application Programming Interfaces (APIs), etc. In some embodiments, the computer system 700 may implement a mail server stored program component. The mail server may be an Internet mail server such as Microsoft Exchange, or the like. The mail server may utilize facilities such as ASP, ActiveX, ANSI C++/C#, Microsoft.NET, Common Gateway Interface (CGI) scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 700 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

### Advantages

An embodiment of the present disclosure provisions to achieve tight tolerance when manufacturing large structures, inexpensively by semi-automating the control system for correction mechanism.

An embodiment of the present disclosure eliminates the use of high skilled operator to operate the machine by providing provisions to couple a low skill operator with semi-automated control system.

An embodiment of the present disclosure provisions inexpensive, less bulky, and low-cost system coupled with the machine, to achieve highly accurate operation.

An embodiment of the present disclosure allows to locate multiple machines to obtain better resolution for controlling operation of at least one machine.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMS, PROMs, RAMS, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

An “article of manufacture” includes non-transitory computer readable medium, and/or hardware logic, in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 6a and 6b show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral numerals:

| Reference Number | Description |
|---|---|
| 100 | Environment |
| 101 | Control System |
| 102 | Target Path Providing Unit |
| 103 | Spatial Position Providing Unit |
| 104 | One or More Sensors |
| 105 | Operating Tool |
| 106 | First Communication Network |
| 107 | Second Communication Network |
| 108 | Processor |
| 109 | I/O Interface |
| 110 | Memory |
| 111 | Modules |
| 112 | Data |
| 201 | Target Path Correction Unit |
| 202 | Position Correction Unit |
| 203 | Alert Generation Module |
| 204 | Other Modules |
| 205 | Target Path Data |
| 206 | Spatial Position Data |
| 207 | Modifying Data |
| 208 | One or More Parameters |
| 209 | Displacing Data |
| 210 | Alert Data |
| 211 | Other Data |
| 301 | Wind Blade |
| 302 | Target Path |
| 303 | Operating Tool |
| 401 | First Laser Tracker |
| 402 | Second Laser Tracker |
| 403.1 | First Wind Blade |
| 403.2 | Second Wind Blade |
| 404.1 | First Machine |
| 404.2 | Second Machine |
| 404.3 | Third Machine |
| 404.4 | Fourth Machine |
| 404.5 | Fifth Machine |
| 404.6 | Sixth Machine |
| 404.7 | Seventh Machine |
| 404.8 | Eight Machine |
| 500 | At Least One Machine |
| 501.1 | Surface |
| 501.2 | Operating Tool |
| 501.3 | Axis |
| 501.4 | Laser Tracker Beacons |
| 501.5 | Frame |
| 501.6 | Tool Holder |
| 501.7 | Sensors |
| 501.8 | Servomotors |
| 700 | Computer System |
| 701 | I/O Interface |
| 702 | Processor |
| 703 | Network Interface |
| 704 | Storage Interface |
| 705 | Memory |
| 706 | User Interface |
| 707 | Operating System |
| 708 | Web Browser |
| 709 | Input Devices |
| 710 | Output Devices |
| 711 | Communication Network |
| 712 | One or More Sensors |
| 713 | Spatial Position Providing Unit |
| 714 | Target Path Providing Unit |
| 715 | Operating Tool |

We claim:

1. A control system (101) for controlling operation of at least one machine in an industrial environment, the control system (101) comprises:
a target path correction unit (201) configured to modify a target path fed to at least one machine in an industrial environment, based on real-time spatial position of the at least one machine; and
a position correction unit (202) configured to correct real-time operating position of the at least one machine, wherein the position correction unit (202) corrects the real-time operating position by:
sensing one or more parameters (208) related to the at least one machine; and
displacing operating tool (105) of the at least one machine, based on the one or more parameters (208), for correcting the real-time operating position of the at least one machine.

2. The control system (101) as claimed in claim 1, further comprises an operator speed detection unit configured to detect speed of operation of the at least one machine.

3. The control system (101) as claimed in claim 1, wherein the target path correction unit (201) is configured to modify the target path by:
calculating tolerance of operation of the at least one handheld machine by checking the real-time spatial position to be in line with the target path feed to the at least one machine;
detecting the tolerance to be greater than a predefined threshold value; and
modifying the target path for feeding to the at least one machine to minimize the tolerance.

4. The control system (101) as claimed in claim 1, wherein the target path feed to the at least one machine is determined using an augmented reality of the industrial environment experienced by a primary operator of the at least one machine, wherein the target path is determined based on one or more inputs provided by the primary operator based on the augmented reality.

5. The control system (101) as claimed in claim 1, wherein the position correction unit (202) for displacing the operating tool (105) comprises:
a holding structure configured to hold the operating tool (105);
one or more actuators configured to displace the operating tool (105) for minimizing value of deviation between the one or more parameters (208) and one or more predefined parameters to zero.

6. The control system (101) as claimed in claim 1, wherein the position correction unit (202) comprises one or more sensors (104) for sensing the one or more parameters (208), wherein the one or more parameters (208) comprises at least one of angular acceleration, linear acceleration, orientation, velocity, and trajectory related to the at least one handheld machine.

7. The control system (101) as claimed in claim 1, further comprises one or more alerting systems provide alert during controlling of the at least one handheld machine.

8. The control system (101) as claimed in claim 1, wherein the real-time operating position of the at least one machine indicates at least one of direction and force of operation of the operating tool (105).

9. A method for controlling operation of at least one machine in an industrial environment, comprising:
modifying a target path fed to at least one machine in an industrial environment, based on real-time spatial position of the at least one machine; and
correcting real-time operating position of the at least one machine, wherein correcting the real-time operating position comprises:
sensing one or more parameters (208) related to the at least one machine; and
displacing operating tool (105) of the at least one machine, based on the one or more parameters (208), for correcting the real-time operating position of the at least one machine.

10. The method as claimed in claim 9 further comprising detecting speed of operation of the at least one machine.

11. The method as claimed in claim 9, wherein modification of the target path is performed by:
calculating tolerance of operation of the at least one handheld machine by checking the real-time spatial position to be in line with the target path feed to the at least one machine;
detecting the tolerance to be greater than a predefined threshold value; and
modifying the target path for feeding to the at least one machine to minimize the tolerance.

12. The method as claimed in claim 9, wherein the target path feed to the at least one machine is determined using an augmented reality of the industrial environment experienced by a primary operator of the at least one machine, wherein the target path is determined based on one or more inputs provided by the primary operator based on the augmented reality.

13. The method as claimed in claim 9, wherein displacing the operating tool (105) is performed to minimize value of deviation between the one or more parameters (208) and one or more predefined parameters to zero.

14. The method as claimed in claim 9, wherein the one or more parameters (208) are sensed using one or more sensors (104), wherein the one or more parameters (208) comprises at least one of angular acceleration, linear acceleration, orientation velocity and trajectory related to the at least one handheld machine.

15. The method as claimed in claim 9, further comprising providing alert during controlling of the at least one handheld machine.

16. The method as claimed in claim 9, wherein the real-time operating position of the at least one machine indicates at least one of direction and force of operation of the operating tool (105).
